(19) United States
(12) Patent Application Publication
(10) Pub. No.: US 2008/0248987 A1
(43) Pub. Date: Oct. 9, 2008

(54) Method For Stabilizing Liquid Detergent Preparations and Corresponding Liquid Detergent Preparations

(75) Inventors: Tanja Seebeck, Bensheim (DE); Helmut Gumbel, Dannenfels (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/090,170

(22) PCT Filed: Oct. 5, 2006
(86) PCT No.: PCT/EP06/67065

§ 371 Date: Apr. 14, 2008

(30) Foreign Application Priority Data
Oct. 14, 2005 (DE) 10 2005 049 701.2

(51) Int. Cl. C11D 11/00

(52) U.S. Cl. 510/405

(57) ABSTRACT

The present invention relates to a process for stabilizing liquid detergent compositions, and also to liquid detergent compositions comprising a copolymer obtainable by free-radical copolymerization of
(A) from 20 to 80% by weight of at least one monomer from the group of the monoethylenically unsaturated monocarboxylic acids, dicarboxylic acids and dicarboxylic anhydrides and
(B) from 20 to 80% by weight of at least one monomer from the group of the aliphatic or aromatic monoolefins.

The present invention relates to a process for stabilizing liquid detergent compositions, and also to liquid detergent compositions comprising a copolymer obtainable by free-radical copolymerization of
(A) from 20 to 80% by weight of at least one monomer from the group of the monoethylenically unsaturated monocarboxylic acids, dicarboxylic acids and dicarboxylic anhydrides and
(B) from 20 to 80% by weight of at least one monomer from the group of the aliphatic or aromatic monoolefins.

In the formulation of liquid detergent compositions, a regular problem is that of phase separation. This occurs especially in the presence of relatively large amounts of builders. Builders are water-soluble inorganic salts, for example the silicates, carbonates and phosphates of alkali metals, especially of sodium, and also organic acids or salts thereof, for example citric acid or sodium citrate, and complexing agents such as methylglycinediacetic acid (MGDA), which are used in order to scavenge the hardness ions of water. Relatively large amounts of builders lead to the salting-out of the washing-active surfactants. Therefore, a balanced surfactant/builder ratio has to be established in the liquid detergent formulation. In order to enable greater freedom to formulate, copolymers which stabilize the liquid detergent compositions are therefore added.

In EP-A-346 995 and 727 479 so-called deflocculating polymers with a hydrophilic polymer backbone and hydrophobic side chains are used for this purpose. The backbone is based on unsaturated monocarboxylic acids, dicarboxylic acids and/or alcohols as monomer units; the side chains which may comprise polyalkylene oxide blocks are bonded to the backbone via ester, ether or amide functions.

WO-A-96/02622 discloses the stabilization of liquid detergents with copolymers of acrylic acid and alkoxylated allyl ethers.

It was an object of the invention to provide copolymers with which liquid detergent compositions can be stabilized advantageously against phase separation.

Accordingly, a process has been found for stabilizing liquid detergent compositions, which comprises adding to the liquid detergent composition a copolymer which is obtainable by free-radical copolymerization of
(A) from 20 to 80% by weight of at least one monomer from the group of the monoethylenically unsaturated monocarboxylic acids, dicarboxylic acids and dicarboxylic anhydrides and
(B) from 20 to 80% by weight of at least one monomer from the group of the aliphatic or aromatic monoolefins.

Also found have been liquid detergent compositions which comprise these copolymers.

Finally, also found has been a process for lowering the viscosity of liquid detergent compositions, which comprises adding these copolymers to the liquid detergent composition.

The copolymers used in accordance with the invention comprise, as the copolymerized monomer (A), a monoethylenically unsaturated monocarboxylic acid or dicarboxylic acid or a mixture of these acids. The acids may be used in the form of their water-soluble salts, especially of the alkali metal salts such as potassium salts and in particular sodium salts, or ammonium salts; the dicarboxylic acids may also be present fully or partly in anhydride form. It will be appreciated that it is also possible to use acid mixtures.

The monomers (A) comprise preferably from 3 to 10 carbon atoms.

Specific examples of suitable monomers (A) include: acrylic acid, methacrylic acid, crotonic acid, vinylacetic acid, maleic acid, maleic anhydride, fumaric acid, citraconic acid, citraconic anhydride and itaconic acid.

Particularly preferred monomers (A) are acrylic acid, methacrylic acid and maleic acid/anhydride, very particular preference being given to maleic acid/anhydride.

The copolymers used in accordance with the invention comprise from 20 to 80% by weight, in particular from 30 to 70% by weight of monomer (A).

As the copolymerized monomer (B), the copolymers used in accordance with the invention comprise at least one aliphatic or aromatic monoolefin. Specific examples of suitable monomers (B) are: 1-butene, isobutene, 1-pentene, 1-hexene, diisobutene (2-methyl-4,4-dimethyl-1-pentene), 1-decene, 1-dodecene, 1-tetradecene, 1-hexadecene, C₁₈-C₂₄-α-olefins such as 1-octadecene, 1-eicosene, 1-docosene and 1-tetracosene, C₂₀-C₂₄-α-olefin mixtures, 1-hexacosene, polyisobutenes having an average of 12 to 100 carbon atoms and styrene.

The copolymers used in accordance with the invention preferably comprise, as component (B), a mixture of (B1) at least one monoolefin having ≦8 carbon atoms and (B2) at least one monoolefin having ≧10 carbon atoms.

Suitable monoolefins (B1) are in particular isobutene, diisobutene and styrene. Particularly suitable monoolefins (B2) are 1-dodecene, C₁₈-C₂₄-α-olefins, C₂₀-C₂₄-α-olefin mixtures and polyisobutenes having an average of from 12 to 100 carbon atoms.

The copolymers used in accordance with the invention comprise from 20 to 80% by weight, preferably from 30 to 70% by weight of monomer (B).

Very particularly preferred copolymers used in accordance with the invention are obtainable by free-radical copolymerization of (A) from 30 to 70% by weight of maleic acid/anhydride, (B1) from 20 to 40% by weight of isobutene and (B2) from 5 to 20% by weight of a C₁₈-C₂₄-α-olefin.

The copolymers used in accordance with the invention have a mean molecular weight M_{w} of from 1000 to 200 000 g/mol, preferably from 2000 to 50 000 g/mol (determined by gel permeation chromatography at room temperature with aqueous eluents).

Their K values are correspondingly from 10 to 150, preferably from 15 to 60 (measured at pH 7 in 1% by weight aqueous solution at 25° C.; according to H. Fikentscher, Cellulose-Chemie, vol. 13, p. 58-64 and 71-74 (1932)).

The copolymers used in accordance with the invention may be prepared by known processes.

Typically, they are obtained in the form of especially aqueous polymer solutions or dispersions which have a solids content of from 10 to 70% by weight, preferably from 25 to 60% by weight.

The copolymers used in accordance with the invention can effectively stabilize liquid detergent compositions against undesired phase separation. In particular, the copolymers used in accordance with the invention can also stabilize structured surfactant phases, for example unilamellar and multilamellar vesicles.

The inventive liquid detergent compositions comprise preferably
(a) from 0.1 to 10% by weight, especially from 0.25 to 5% by weight, of at least one inventive copolymer,
(b) from 5 to 70% by weight, especially from 15 to 55% by weight, in particular from 25 to 45% by weight, of at least one anionic, nonionic, cationic, amphoteric and/or zwitterionic surfactant, and
(c) from 1 to 60% by weight, especially from 5 to 40% by weight, of at least one electrolyte.

Suitable nonionic surfactants (b) are in particular:
alkoxylated C₈-C₂₂-alcohols such as fatty alcohol alkoxylates, oxo alcohol alkoxylates and Guerbet alcohol alkoxylates: the alkoxylation can be effected with C₂-C₂₀-alkylene oxides, preferably ethylene oxide, propylene oxide and/or butylene oxide. Block copolymers or random copolymers may be present. Per mole of alcohol, they comprise typically from 2 to 50 mol, preferably from 3 to 20 mol of at least one alkylene oxide. The preferred alkylene oxide is ethylene oxide. The alcohols have preferably from 10 to 18 carbon atoms.
alkyl phenol alkoxylates, especially alkylphenol ethoxylates which comprise C₆-C₁₄-alkyl chains and from 5 to 30 mol of alkylene oxide/mole.
alkylpolyglucosides which comprise C₈-C₂₂-alkyl, preferably C₁₀-C₁₈-alkyl chains and generally from 1 to 20, preferably from 1.1 to 5 glucoside units.
N-alkylglucamides, fatty acid amide alkoxylates, fatty acid alkanolamide alkoxylates and block copolymers of ethylene oxide, propylene oxide and/or butylene oxide.

Suitable anionic surfactants are, for example:
sulfates of (fatty) alcohols having from 8 to 22, preferably from 10 to 18 carbon atoms, especially C₉C₁₁-alcohol sulfates, C₁₂C₁₄-alcohol sulfates, C₁₂-C₁₈-alcohol sulfates, lauryl sulfate, cetyl sulfate, myristyl sulfate, palmityl sulfate, stearyl sulfate and tallow fat alcohol sulfate.
sulfated alkoxylated C₈-C₂₂-alcohols (alkyl ether sulfates): compounds of this type are prepared, for example, by first alkoxylating a C₈-C₂₂-alcohol, preferably a C₁₀-C₁₈-alcohol, for example a fatty alcohol, and then sulfating the alkoxylation product. For the alkoxylation, preference is given to using ethylene oxide.
linear C₈-C₂₀-alkylbenzenesulfonates (LAS), preferably linear C₉-C₁₃-alkylbenzenesulfonates and -alkyltoluenesulfonates.
alkanesulfonates, especially C₈-C₂₄-alkanesulfonates, preferably C₁₀-C₁₈-alkanesulfonates.
fatty acid ester sulfonates of the formula R¹CH(SO₃M)CO₂R² in which R¹ is C₆-C₂₀-alkyl, preferably C₈-C₁₆-alkyl, and R² is C₁-C₄-alkyl, preferably methyl or ethyl, and M is hydrogen, a water-soluble cation, for example alkali metal cation or ammonium ion.
olefinsulfonates which from 8 to 22, preferably from 12 to 18, carbon atoms.
isethionates, especially acyl isethionates and N-acyl taurates.
N-acyl sarcosinates.
sulfosuccinates (mono- or diesters of sulfosuccinic acid) and alkyl succinates.
organic phosphate esters, especially mixtures of mono- and diester phosphates of hydroxyl-terminated alkoxide condensates and salts thereof. These include polyoxalkylated alkylarylphosphate esters, for example based on alkoxylated C₈-C₂₂-alcohols or alkoxylated phenol derivatives.
soaps such as the sodium and potassium salts of C₈-C₂₄-carboxylic acids.

The anionic surfactants are added to the detergent preferably in the form of salts. Suitable salts are, for example, alkali metal salts such as sodium, potassium and lithium salts, and ammonium salts such as hydroxyethylammonium, di(hydroxyethyl)ammonium and tri(hydroxyethyl)ammonium salts.

Particularly suitable cationic surfactants include:
C₇-C₂₅-alkylamines;
N,N-dimethyl-N—(C₇-C₂₅-hydroxyalkyl)ammonium salts;
mono- and di(C₇-C₂₅-alkyl)dimethylammonium compounds quaternized with alkylating agents;
ester quats, especially quaternary esterified mono-, di- and trialkanolamines which have been esterified with C₈-C₂₂-carboxylic acids;
imidazoline quats, especially 1-alkylimidazolinium salts of the formulae I or II

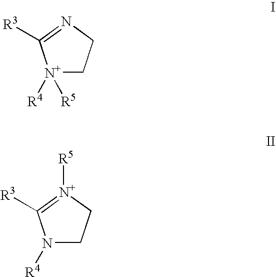

in which the variables are defined as follows:
R³ is C₁-C₂₅-alkyl or C₂-C₂₅-alkenyl;
R⁴ is C₁-C₄-alkyl or C₁-C₄-hydroxyalkyl;
R⁵ is C₁-C₄-alkyl, C₁-C₄-hydroxyalkyl or an R³—(CO)—X—(CH₂)ₚ— radical (X: —O— or —NH—; p: 2 or 3),
where at least one R³ radical is C₇-C₂₂-alkyl.

Suitable amphoteric surfactants are derivatives of aliphatic or heterocyclic, secondary and tertiary amines in which the aliphatic radicals preferably have from 8 to 18 carbon atoms and at least one radical comprises one or more anionic water-soluble groups, for example one or more carboxylate, sulfonate, sulfate, phosphate or phosphonate groups.

Examples of suitable amphoteric surfactants are:
3-(alkylamino)propionates, (alkylamino)acetates, 3-(dialkylamino)propionates and (dialkylamino)acetates, where preferably at least one alkyl group comprises from 8 to 18 carbon atoms.
3-[(3-alkylaminopropyl)amino]propionates and [(3-alkylaminopropyl)amino]acetates, where the alkyl group preferably comprises from 8 to 18 carbon atoms.
[(2-acylaminoethyl)(2-hydroxyethyl)amino]acetates where the acyl group preferably comprises from 8 to 18 carbon atoms.
(alkylamino)propanesulfonates where the alkyl group preferably comprises from 8 to 18 carbon atoms.

Suitable zwitterionic surfactants are, for example:
amine oxides, especially alkyldimethylamine oxides and alkyldiethylamine oxides, where the alkyl group preferably comprises from 8 to 18 carbon atoms.
betaines, especially carbobetaines, sulfobetaines and phosphobetaines, such as:
R⁶(R⁷)₂N⁺(CH₂)ₙCOO— with the following preferred definition of the variables:
R⁶: C₈-C₁₈-alkyl; R⁷: C₁-C₃-alkyl; n: from 1 to 5.
R⁶CONH(CH₂)ₘ(R⁷)₂N⁺(CH₂)ₙCOO— with the following preferred definition of the variables: R⁶: C₇-C₁₇-alkyl; R⁷: C₁-C₃-alkyl; n, m: each independently from 1 to 5.
R⁶(R⁷)₂N⁺(CH₂)ₙSO₃— with the following preferred definition of the variables:
R⁶: C₈-C₁₈-alkyl; R⁷: C₁-C₃-alkyl; n: from 1 to 5.
cocoamidopropylbetaine.

Detailed descriptions of amphoteric and zwitterionic surfactants can also be found in EP-A-851 023 and also in Die Tenside [The surfactants], Carl Hanser Verlag, 1993.

As component (c), the inventive liquid detergent compositions comprise at least one electrolyte. The term “electrolyte” is understood to mean all ionic water-soluble substances. Examples of suitable electrolytes are water-soluble inorganic builders and organic (co)builders.

Suitable electrolytes are in particular:
carbonates and hydrogencarbonates: these may be used in the form of their alkali metal, alkaline earth metal or ammonium salts. Preference is given to the carbonates and hydrogencarbonates of sodium, lithium and magnesium, especially sodium carbonate and/or sodium hydrogencarbonate.
polyphosphates, such as pentasodium triphosphate, pyrophosphates and orthophosphates.
low molecular weight carboxylic acids such as citric acid, hydrophobically modified citric acid, for example agaric acid, malic acid, tartaric acid, gluconic acid, glutaric acid, succinic acid, imidodisuccinic acid, hydroxydisuccinic acid, oxydisuccinic acid, propanetricarboxylic acid, butanetetracarboxylic acid, cyclopentanetetracarboxylic acid, alkyl- and alkenylsuccinic acids and aminopolycarboxylic acids, for example nitrilotriacetic acid, β-alaninediacetic acid, ethylenediaminetetraacetic acid, diethylenetriaminepentaacetic acid, serinediacetic acid, isoserinediacetic acid, glutamic acid diacetic acid, N-(2-hydroxyethyl)iminodiacetic acid, ethylenediaminedisuccinic acid and methyl- and ethylglycinediacetic acid, and also salts thereof.
crystalline and amorphous silicates, especially disilicates, metasilicates and sheet silicates, e.g. δ- and β-Na₂Si₂O₅. The silicates may be used in the form of their alkali metal, alkaline earth metal or ammonium salts; preference is given to the silicates of sodium, lithium and magnesium.
alkali metal hydroxides, especially sodium hydroxide and potassium hydroxide.
further inorganic salts such as the chlorides, sulfates and borates of alkali metals and alkaline earth metals.

The inventive liquid detergent compositions may additionally comprise further ingredients such as
crystalline and amorphous aluminosilicates with ion-exchanging properties, in particular zeolites: various types of zeolites are suitable, especially zeolites A, X, B, P, MAP and HS in their sodium form or in forms in which sodium has been exchanged partly for other cations such as Li, K, Ca, Mg or ammonium.
oligomeric and polymeric carboxylic acids such as homopolymers of acrylic acid and aspartic acid, oligomaleic acids, copolymers of maleic acid with acrylic acid, methacrylic acid or C₂-C₂₂-olefins, for example isobutene or long-chain α-olefins, vinyl C₁-C₈-alkyl ethers, vinyl acetate, vinyl propionate, (meth)acrylic esters of C₁-C₈-alcohols and styrene. Preference is given to the homopolymers of acrylic acid and copolymers of acrylic acid with maleic acid. The oligomeric and polymeric carboxylic acids are used in acid form or as the sodium salt.
other customary ingredients such as enzymes, perfume, corrosion inhibitors, bleaches, bleach activators, bleach catalysts, dye transfer inhibitors, graying inhibitors, antiredeposition polymers, soil-release polyesters, fiber protection and color protection additives, optical brighteners, silicones, dyes, bactericides, preservatives, organic solvents, solubilizers, hydrotropes, thickeners and alkanolamines.

Detergent ingredients are common knowledge. Detailed descriptions can be found, for example, in WO-A-99/06524 and 99/04313 and in Liquid Detergents, Editor: Kuo-Yann Lai, Surfactant Sci. Ser., Vol. 67, Marcel Decker, New York, 1997, p. 272-304.

### EXAMPLES

The stability of various liquid detergent compositions was investigated in the presence and absence of copolymer P.

Copolymer P was a copolymer of maleic anhydride, isobutene and 1-octadecene in a weight ratio of 65:26:9 which had a mean molecular weight M_{w} of 3000 g/mol and a K value of 24 (measured at pH 7 in 1% by weight aqueous solution at 25° C.). The copolymer was used in the form of a 40% by weight aqueous solution.

To test their stability, the liquid detergent compositions were stored at room temperature for 4 weeks.

Their composition is tabulated below. The amounts reported for the polymeric ingredients are each based on the solid substances.

| | Det 1 | Det 2 | Det 3 | Det 4 |
|---|---|---|---|---|
| Ingredients | [% by wt.] | [% by wt.] | [% by wt.] | [% by wt.] |
| Dodecylbenzenesulfonate, Na salt | 25 | 25 | 25 | 22 |
| C_{13/15} oxo alcohol•7 EO | 7 | 7 | 7 | 7 |
| Sodium carbonate | — | 15 | 8 | 8 |
| Sodium citrate | 17 | — | 5 | 5 |
| Zeolite A | — | — | 10 | 10 |
| Copolymer P | 2 | 1 | 1 | 1 |
| Polyvinylpyrrolidone (M_{w} 40 000) | — | — | — | 2 |
| Demineralized water | 49 | 52 | 44 | 45 |
| | Det 5 | Det 6 | Det 7 | Det 8 |
| Ingredients | [% by wt.] | [% by wt.] | [% by wt.] | [% by wt.] |
| Dodecylbenzenesulfonate, Na salt | 24 | 24 | 22 | 25 |
| C₁₃ oxo alcohol•8 EO | — | 8 | — | — |
| C_{13/15} oxo alcohol•7 EO | — | — | 7 | 7 |
| C_{13/15} oxo alcohol•8 EO | 8 | — | — | — |
| Sodium hydrogencarbonate | 5 | 5 | 5 | 5 |
| Methyl glycinediacetic acid, tri-Na | 10 | — | — | — |
| salt | | | | |
| Sodium citrate | — | 10 | 12.5 | 10 |
| Zeolite A | — | — | — | 8 |
| Copolymer P | 2 | 2 | 2 | 2 |
| Demineralized water | 51 | 51 | 51.5 | 43 |
| | Det 9 | Det 10 | Det 11 | Det 12 |
| Ingredients | [% by wt.] | [% by wt] | [% by wt.] | [% by wt.] |
| Dodecylbenzenesulfonate, Na salt | 22 | 22 | 22 | 22 |
| C_{13/15} oxo alcohol•7 EO | 7 | 7 | 7 | 7 |
| Sodium carbonate | 8 | 8 | 8 | 8 |
| Sodium citrate | 5 | 5 | 5 | 5 |
| Zeolite A | 10 | 10 | 10 | 10 |
| Copolymer P | 2 | 2 | 2 | 2 |
| Sokalan ® CP 5⁽¹⁾ | 1 | — | — | — |
| Sokalan CP 35⁽²⁾ | — | 1 | — | — |
| Sokalan HP 22 G⁽³⁾ | — | — | 1 | — |
| Sokalan HP 56⁽⁴⁾ | — | — | — | 1 |
| Demineralized water | 45 | 45 | 45 | 45 |

Sokalan ®: registered brand of BASF Aktiengesellschaft
⁽¹⁾acrylic acid/maleic acid copolymer; graying and incrustation inhibitor
⁽²⁾modified polycarboxylate, Na salt; graying inhibitor
⁽³⁾copolymer with nonionic character; antiredeposition polymer
⁽⁴⁾vinylpyrrolidone/vinylimidazole copolymer; dye transfer inhibitor

All liquid detergent compositions showed no phase separation after the storage.

Liquids tested for comparison, which did not comprise any polymer P, in contrast, showed distinct separation even after a few hours.

1. A process for stabilizing a liquid detergent composition, which comprises adding to the liquid detergent composition a copolymer which is prepared by free-radical copolymerization of
(A) from 20 to 80% by weight of at least one monomer from the group of the monoethylenically unsaturated monocarboxylic acids, dicarboxylic acids and dicarboxylic anhydrides and
(B) from 20 to 80% by weight of at least one monomer from the group of the aliphatic or aromatic monoolefins.

2. The process according to claim 1, wherein a copolymer is prepared which is based on at least one monomer (A) from the group of maleic acid, maleic anhydride and acrylic acid.

3. The process according to claim 1, wherein a copolymer is prepared which is based on at least one monomer (B) from the group of isobutene, diisobutene, 1-dodecene, C₁₈-C₂₄-α-olefins, C₂₀-C₂₄-α-olefin mixtures, polyisobutenes having an average of from 12 to 100 carbon atoms and styrene.

4. The process according to claim 1, wherein a copolymer is prepared which is based on a mixture of (B1) at least one monoolefin having ≦8 carbon atoms and (B2) at least one monoolefin having ≧10 carbon atoms as component (B).

5. The process according to claim 1, wherein a copolymer is prepared which is obtainable by free-radical copolymerization of (A) from 30 to 70% by weight of maleic acid or maleic anhydride, (B1) from 20 to 40% by weight of isobutene and (B2) from 5 to 20% by weight of a C₁₈-C₂₄-α-olefin.

6. The process according to claim 1, wherein the liquid detergent compositions have composition has structured surfactant phases.

7. A liquid detergent composition comprising a copolymer according to claim 1.

8. A liquid detergent composition comprising
(a) from 0.1 to 10% by weight of at least one copolymer according to claim 1,
(b) from 5 to 70% by weight of at least one anionic, nonionic, cationic, amphoteric and/or zwitterionic surfactant and
(c) from 1 to 60% by weight of at least one electrolyte.

9. A process for lowering the viscosity of a liquid detergent composition, which comprises adding a copolymer according to claim 1 to the liquid detergent composition.
